(19) United States
(12) Patent Application Publication
(10) Pub. No.: US 2026/0197299 A1
(43) Pub. Date: Jul. 9, 2026

(54) NODE SCORING IN REMOTE CONNECTIVITY ENABLEMENT

(71) Applicant: Dell Products L.P., Round Rock, TX (US)

(72) Inventors: Xiang HUANG, Shanghai (CN); Mackie QU, Shanghai (CN)

(73) Assignee: Dell Products L.P., Round Rock, TX (US)

(21) Appl. No.: 19/028,724

(22) Filed: Jan. 17, 2025

(30) Foreign Application Priority Data
Jan. 6, 2025 (CN) 202510016001.3

(51) Int. Cl. H04L 9/40

(52) U.S. Cl. CPC H04L 63/04; H04L 63/102

(57) ABSTRACT

An information handling system may include at least one processor and a memory. The information handling system may be configured to select a node from a plurality of nodes of an information handling system cluster for establishing secure communication with a backend system by: loading a scoring profile that specifies one or more scoring rules for the plurality of nodes; determining a node score for each node based on the scoring profile; and attempting to establish the secure communication with the backend system using the node having the highest node score.

### TECHNICAL FIELD

The present disclosure relates in general to information handling systems, and more particularly to selecting a node of an information handling system cluster to perform communication with a backend system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSAN™ system, or any other SDS cluster system).

In the HCI context (as well as other contexts), information handling systems may execute virtual machines (VMs) or containerized workloads for various purposes. A VM or container may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

Some HCI systems use a cloud platform manager (e.g., APEX Cloud Platform™ from Dell®) for handling certain cloud management tasks. The connectivity between the cloud platform manager of an HCI system and the various manufacturer backend systems that support it is increasingly important. Such backend systems may be used for remote cluster management, installation of updates, adding or removing nodes, etc.

In some cases, the HCI system may use one of its nodes to handle the authentication procedure with the backend systems, and then the cluster communicates with the backend via that node. This may involve using a cryptographic connectivity key that has been bound with that node. The connectivity key installed in the node is then used to authenticate and create a secure connection between the cloud platform manager executing on the local cluster and the manufacturer backend. For purposes of this disclosure, the term “connectivity key” refers to any cryptographic key, signature, token, etc. that is usable to establish a secure communications link between one information handling system and another.

Determining a suitable node capable of providing the backend connectivity is an important task. In some cases, the node must be capable of undergoing authentication with the support backend, which requires the node to either map to specific key data or use a dynamic passcode. Given the complexity of datacenter environments, it is not always trivial to select a suitable node. Some nodes may lack the necessary authentication data or be in an abnormal state, leading to failures in establishing remote connectivity services between the cluster and the backend. Embodiments of this disclosure are directed to improved techniques for selecting the node that will be used to establish connectivity.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with communication node election may be reduced or eliminated.

In accordance with embodiments of the present disclosure, an information handling system may include at least one processor and a memory. The information handling system may be configured to select a node from a plurality of nodes of an information handling system cluster for establishing secure communication with a backend system by: loading a scoring profile that specifies one or more scoring rules for the plurality of nodes; determining a node score for each node based on the scoring profile; and attempting to establish the secure communication with the backend system using the node having the highest node score.

In accordance with these and other embodiments of the present disclosure, a method for selecting a node from a plurality of nodes of an information handling system cluster for establishing secure communication with a backend system may include: an information handling system loading a scoring profile that specifies one or more scoring rules for the plurality of nodes; the information handling system determining a node score for each node based on the scoring profile; and the information handling system attempting to establish the secure communication with the backend system using the node having the highest node score.

In accordance with these and other embodiments of the present disclosure, an article of manufacture may include a non-transitory, computer-readable medium having computer-executable instructions thereon that are executable by a processor of an information handling system for: selecting a node from a plurality of nodes of an information handling system cluster for establishing secure communication with a backend system by: loading a scoring profile that specifies one or more scoring rules for the plurality of nodes; determining a node score for each node based on the scoring profile; and attempting to establish the secure communication with the backend system using the node having the highest node score.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates an example architecture, in accordance with embodiments of the present disclosure.

### DETAILED DESCRIPTION

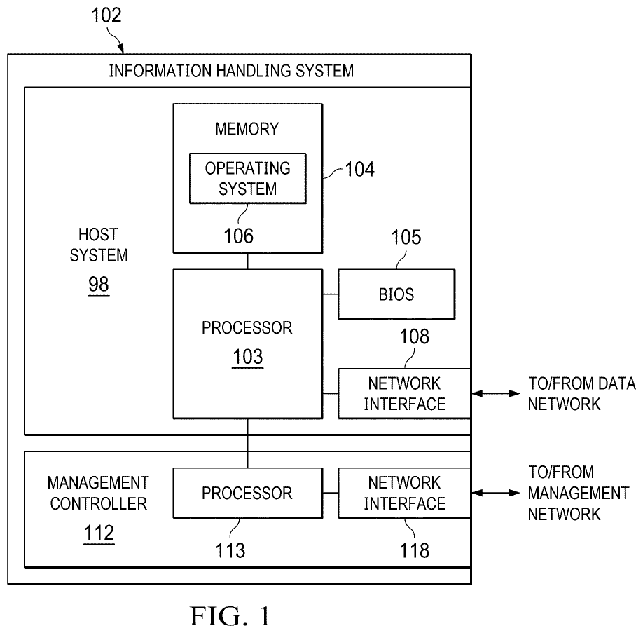

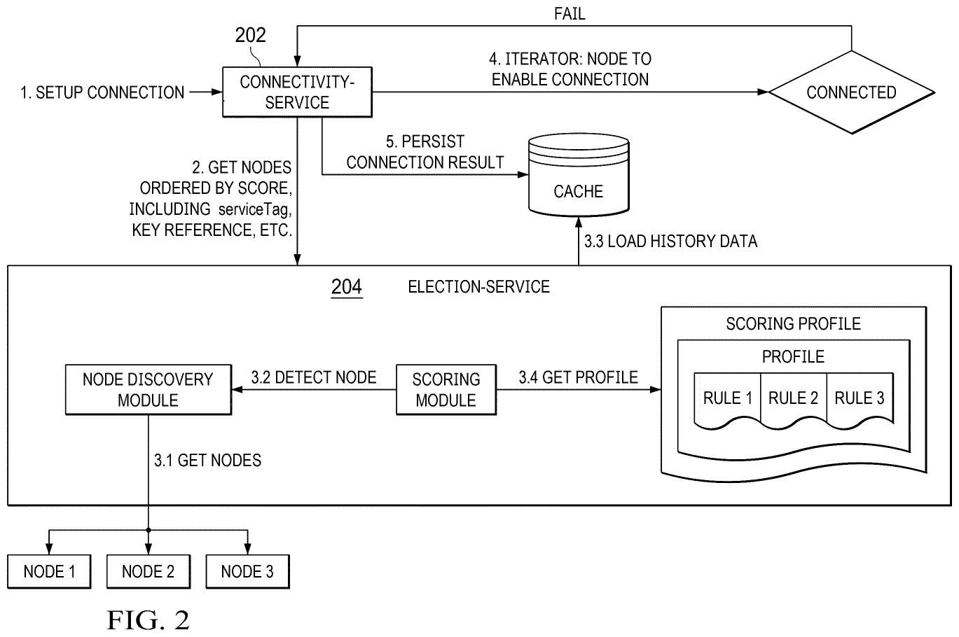

Preferred embodiments and their advantages are best understood by reference to FIGS. 1 and 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, information handling system 102 may be a node of an HCI system that is configured to communicatively couple to a remote system such as a manufacturer backend server. This disclosure provides techniques for selecting an appropriate active node for enabling such connectivity.

Embodiments may elect nodes based on predefined scoring rules. The node election process may begin by loading a scoring profile that includes one or more scoring rules, followed by evaluating each node according to those scoring rules. The node with the highest score may then be designated as the target node. If the target node fails to enable connectivity, the process may then choose the node with the second highest score, continuing down the list of node scores until a successful activation is accomplished.

In some cases, for support reasons, it may be desirable for some particular node to be used as the connectivity node. In that situation, embodiments may allow for a user selection to override the scoring (e.g., by forcing that node to receive the highest score), so that the user can essentially manually pick that node and use it for connectivity.

FIG. 2 shows an example architecture diagram, according to some embodiments. This embodiment relies on two services that may be run on an information handling system cluster. As shown, election-service 204 may be used to select which node will be used as the connectivity node.

The connectivity-service 202 may then receive an instruction to set up a connection to the backend system, and once the nodes have been scored by election-service 204, connectivity-service 202 may attempt to establish a connection from the highest-scoring node to the backend. If connectivity from that node fails for some reason, then connectivity-service 202 may iteratively proceed down the list of nodes in order of their scores, attempting connectivity with each. The results of each connection attempt (successful or failed) may also be written to the cache for use in later node scoring rounds.

As shown, election-service 204 may include three components: a node discovery module, a scoring module, and a scoring profile.

The node discovery module may get a list of the cluster's nodes and determine various items of node information for each node. For example, the node discovery module may retrieve the node's service tag, its network connection status, its general hardware and software health status, etc.

The scoring module may then be used to calculate scores for each node. For example, the scoring module may retrieve a list of detected nodes from the node discovery module, then load their connection history from the cache. The scoring module may also load a scoring profile, which indicates the exact scoring rules that are to be used. Based on these rules, the scoring module determines scores for each node.

The scoring profile module allows the system to adapt to different scenarios by supporting multiple scoring profiles, selecting the appropriate scoring profile based on the situation. Each profile contains one or more scoring rules, which may be specified in a configuration file (e.g., in YAML or any suitable format). In some implementations, the rules may be implemented in one or more associated executable scripts.

In general, each scoring rule may determine a score based on a criterion such as node network connectivity, node health status (e.g., including any critical or warning alarms), the presence or absence of a connectivity key on the node, prior history of successful or unsuccessful connection attempts, etc. Each profile may refer to one or more of these scoring rules. An example profile is shown at Listing 1 below.
profile: scoring-1
profile-alias: scoring-in-hci-cluster
description: “example”
rules:
   calculate_connection_status
   calculate_health_state
   calculate_key_data
   calculate_base_on_history_ops
   calculate_priority
Listing 1.

Each rule referred to by a profile may also be defined. Two examples are shown below at Listing 2, which calculate a score based on a node's connection status and a score based on a defined priority for the node.
id: calculate_connection_status
description: “Calculate a score by connection status”
command: <an executable script returns related score>
args: <any additional arguments>
timeout: 30 s
id: calculate_priority
description: “Execute calculation by priority. A higher priority for a node results in a higher score.”
command: <an executable script returns related score>
args: <any additional arguments>
timeout: 30 s
Listing 2.

When invoked, the scoring profile may execute a script for each script specified by the rules listed therein. The scripts may run and return a score (e.g., a numerical value). In some implementations, these individual scores may be combined (e.g., by adding their numerical values together) to arrive at an overall score for the node.

Generally, the rules may be formulated so that nodes having a higher probability of successful connectivity receive higher scores. For example, nodes including a connectivity key may receive higher scores. Nodes with a healthy hardware status may receive higher scores. Nodes with stable network connection status may receive higher scores. Nodes with a strong historical success record as indicated by the cache may receive higher scores. Further, as noted above, a user may manually assign the highest score to a specific node to ensure its election in some cases.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory;
wherein the information handling system is configured to select a node from a plurality of nodes of an information handling system cluster for establishing secure communication with a backend system by:
loading a scoring profile that specifies one or more scoring rules for the plurality of nodes;
determining a node score for each node based on the scoring profile; and
attempting to establish the secure communication with the backend system using the node having the highest node score.

2. The information handling system of claim 1, wherein the information handling system cluster is a hyper-converged infrastructure (HCI) system.

3. The information handling system of claim 1, wherein in response to an unsuccessful connection using the node having the highest node score, the information handling system is configured to iteratively attempt to establish the secure communication with the backend system using other nodes in order of their corresponding node scores.

4. The information handling system of claim 1, wherein the one or more scoring rules includes a scoring rule based on at least one factor selected from the group consisting of: presence of a connectivity, hardware health status, and network connection status.

5. The information handling system of claim 1, wherein the one or more scoring rules are implemented as executable scripts.

6. The information handling system of claim 1, wherein the information handling system is further configured to store a cache indicative of prior successful and/or unsuccessful connectivity attempts for the nodes, and wherein the one or more scoring rules are further based on the cache.

7. A method for selecting a node from a plurality of nodes of an information handling system cluster for establishing secure communication with a backend system, the method comprising:
an information handling system loading a scoring profile that specifies one or more scoring rules for the plurality of nodes;
the information handling system determining a node score for each node based on the scoring profile; and
the information handling system attempting to establish the secure communication with the backend system using the node having the highest node score.

8. The method of claim 7, wherein the information handling system cluster is a hyper-converged infrastructure (HCI) system.

9. The method of claim 7, further comprising, in response to an unsuccessful connection using the node having the highest node score, iteratively attempting to establish the secure communication with the backend system using other nodes in order of their corresponding node scores.

10. The method of claim 7, wherein the one or more scoring rules includes a scoring rule based on at least one factor selected from the group consisting of: presence of a connectivity, hardware health status, and network connection status.

11. The method of claim 7, wherein the one or more scoring rules are implemented as executable scripts.

12. The method of claim 7, further comprising storing a cache indicative of prior successful and/or unsuccessful connectivity attempts for the nodes, wherein the one or more scoring rules are further based on the cache.

13. An article of manufacture comprising a non-transitory, computer-readable medium having computer-executable instructions thereon that are executable by a processor of an information handling system for:
selecting a node from a plurality of nodes of an information handling system cluster for establishing secure communication with a backend system by:
loading a scoring profile that specifies one or more scoring rules for the plurality of nodes;
determining a node score for each node based on the scoring profile; and
attempting to establish the secure communication with the backend system using the node having the highest node score.

14. The article of manufacture of claim 13, wherein the information handling system cluster is a hyper-converged infrastructure (HCI) system.

15. The article of manufacture of claim 13, wherein in response to an unsuccessful connection using the node having the highest node score, the information handling system is configured to iteratively attempt to establish the secure communication with the backend system using other nodes in order of their corresponding node scores.

16. The article of manufacture of claim 13, wherein the one or more scoring rules includes a scoring rule based on at least one factor selected from the group consisting of: presence of a connectivity, hardware health status, and network connection status.

17. The article of manufacture of claim 13, wherein the one or more scoring rules are implemented as executable scripts.

18. The article of manufacture of claim 13, wherein the information handling system is further configured to store a cache indicative of prior successful and/or unsuccessful connectivity attempts for the nodes, and wherein the one or more scoring rules are further based on the cache.
